(19) United States
(12) Patent Application Publication
(10) Pub. No.: US 2009/0244376 A1
(43) Pub. Date: Oct. 1, 2009

(54) PROJECTOR DEVICE AND PROJECTOR SYSTEM USING THE SAME

(75) Inventors: Takehiko Asano, Toyonaka-shi (JP); Koki Yamamoto, Daito-shi (JP)

Correspondence Address: OCCHIUTI ROHLICEK & TSAO, LLP, 10 FAWCETT STREET, CAMBRIDGE, MA, 02138, US

(73) Assignee: Sanyo Electric Co., Ltd., Osaka (JP)

(21) Appl. No.: 12/399,297

(22) Filed: Mar. 6, 2009

(30) Foreign Application Priority Data
Mar. 27, 2008 (JP) 2008-084384

(51) Int. Cl. H04N 5/445; H04N 9/31

(52) U.S. Cl. 348/564; 348/744; 348/E05.104; 348/E09.025

(57) ABSTRACT

A projector that displays a projection frame includes an operation unit to select a projection mode designating the number of split screens in the projection frame and the location, size, and orientation of each split screen. An input unit processes graphical signal data provided from an external graphical signal generator to generate processed graphical signal data. A distributor distributes the processed graphical signal data to graphical signal processing circuits, each performing data conversion and adjustment in accordance with the projection mode on the distributed graphical signal data to generate adjusted graphical signal data for one of the split screens. A synthesizer combines the adjusted graphical signal data to generate combined graphical signal data. A projection unit projects the combined graphical signal data as a single projection frame.

### CROSS-REFERENCE TO RELATED APPLICATIONS

This application is based upon and claims the benefit of priority from prior Japanese Patent Application No. 2008-084384, filed on Mar. 27, 2008, the entire contents of which are incorporated herein by reference.

### BACKGROUND OF THE INVENTION

The present invention relates to a projector device that combines data from a plurality of graphical signals, each of which has undergone graphical signal processing, to form combined graphical signal data for projection as a single projection frame. The present invention also relates to a projector system using such a projector device.

A graphic display device that projects a single projection frame including a plurality of split screens is known in the prior art. The plurality of split screens simultaneously display different graphical images. The graphic display device of the prior art receives data of a plurality of graphical signals, stores the data for each graphical signal in a memory, performs image quality correction on the graphical signal data stored in each memory, and adjusts the size and location allocated for the graphical signal data. Then, the graphic display device combines the data of the graphical signals to generate data for a combined graphical signal and displays a single projection frame in accordance with the combined graphical signal data.

Such a graphic display device includes a television that uses the display technology described in Japanese Laid-Open Patent Publication No. 2001-86367. A projector device that uses this display technology is also known. Such a projector device processes the data of a plurality of input graphical signals to project a projection frame, which includes a plurality of split screens.

However, a projector device has not been developed to generate data for a plurality of graphical signals from the data of a single graphical signal, process the generated data for each graphical signal (independently), and project a single projection frame including a plurality of split screens. This is because a projection frame is required to be simultaneously displayed on a plurality of split screens only when showing the projection frame to a number of persons. In addition, it is not inconvenient to use a prior art system that simultaneously displays the same graphical image on a plurality of dispersedly arranged projector devices.

### SUMMARY OF THE INVENTION

There is a tendency for the focal distance to be shortened in recent projector devices. By shortening the focal distance, a graphical image can easily be projected downward onto a horizontal surface, such as the surface of a table, from a projector device set above the horizontal surface. There are new demands for projector devices that can use a table surface or a floor surface as a projection surface for displaying graphical images during conferences and exhibitions. However, referring to FIG. 11(a), a projector device 101 of a short focal distance type in the prior art uses the information of a single input for a single graphical image. That is, the projector device 101 performs single-input single-screen display in which a single projection frame 102 is displayed on a table surface 103 (for example, refer to Japanese Laid-Open Patent Publication No. 2004-85752). Referring to FIG. 11(b), the projection frame 102 is viewed in a proper direction by some viewers 104. However, other viewers view the projection frame 102 in improper directions, such as a sideward or opposite directions. Thus, not everyone can easily view the graphical image.

In a projector device of the short focal distance type, the same graphical image may be displayed in a plurality of split screens using the technology taught in the above-mentioned '367 publication. However, in the graphic display device of the '367 publication, the split screens included in a single projection frame are all displayed in the same direction. Accordingly, as shown in FIG. 12, in a projector device 111 of a reference example that applies the technology described in the '367 publication, the information input from a plurality of external graphical signal generators is projected onto a table surface 112 as graphical images oriented in the same direction in a plurality of split screens 113. Thus, not all of the viewers 114 can easily view the graphical image.

The present invention provides a projector device that simultaneously displays the same graphical image in a plurality of split screens forming a projection frame, while adjusting the location of each split screen and the orientation of each split screen. Further, the present invention provides a projector device that simultaneously displays different graphical images in a plurality of split screens forming a projection frame projected, while adjusting the location and the orientation of each split screen.

A first aspect is a projector device including an operation unit which selects a projection mode for designating the number of split screens forming a projection frame, the location of each split screen, the size of each split screen, and the orientation of each split screen. An input connector I connected to an external graphical signal generator. An input unit performs input signal processing on graphical signal data provided to the input connector from the external graphical signal generator to generate processed graphical signal data. A distributor distributes the processed graphical signal data generated in the input unit to a plurality of graphical signal processing circuits. Each of the graphical signal processing circuits perform data conversion and adjustment in accordance with the projection mode selected by the operation unit on the distributed graphical signal data to generate adjusted graphical signal data conforming to the size, location, and orientation of a corresponding one of the split screens. A synthesizer combines the adjusted graphical signal data provided from the plurality of graphical signal processing circuits to generate combined graphical signal data. A projection unit projects the combined graphical signal data as a single projection frame.

A second aspect is a projector device including an operation unit which selects a projection mode for designating the number of split screens forming a projection frame, the location of each split screen, the size of each split screen, the orientation of each split screen, and graphical signal data that is to be displayed in each split screen. A plurality of input connectors are respectively connected to a plurality of external graphical signal generators. A plurality of input units each perform input signal processing on the graphical signal data provided to a corresponding one of the plurality of input connectors from a corresponding one of the plurality of external graphical signal generators to generate processed graphical signal data. A plurality of graphical signal processing circuits each perform data conversion and adjustment in accordance with the projection mode selected by the operation unit on the processed graphical signal data generated by one of the plurality of input units to generate adjusted graphical signal data conforming to the size, location, and orientation of a corresponding one of the split screens. A synthesizer combines the adjusted graphical signal data provided from the plurality of graphical signal processing circuits to generate combined graphical signal data. A projection unit projects the combined graphical signal data as a single projection frame.

A third aspect is a projector device including an operation unit which selects a projection mode for designating the number of split screens forming a projection frame, the location of each split screen, the size of each split screen, the orientation of each split screen, and graphical signal data that is to be displayed in each split screen. A plurality of input connectors are respectively connected to a plurality of external graphical signal generators. A plurality of input units each perform input signal processing on the graphical signal data provided to a corresponding one of the plurality of input connectors from a corresponding one of the plurality of external graphical signal generators to generate processed graphical signal data. A plurality of distributors respectively receive the processed graphical signal data from the plurality of input units, with each of the distributors distributing the received processed graphical signal data to a plurality of graphical signal processing circuits, and each of the plurality of graphical signal processing circuits performing data conversion and adjustment in accordance with the projection mode selected by the operation unit on the processed graphical signal data generated by one of the plurality of input units to generate adjusted graphical signal data conforming to the size, location, and orientation of a corresponding one of the split screens. A synthesizer which combines the adjusted graphical signal data provided from the plurality of graphical signal processing circuits to generate combined graphical signal data. A projection unit which projects the combined graphical signal data as a single projection frame.

A fourth aspect is a projector system including the projector device according to the first aspect and a single external graphical signal generator connected to the projector device. The projector device downwardly projects a plurality of split screens that form a single projection frame. The orientation of each of the plurality of splits screens is adjusted so that the graphical images in the split screens are viewed in proper directions from a plurality of positions near the projection frame.

A fifth aspect is a projector system including the projector device according to the third aspect and a single external graphical signal generator connected to the projector device. The projector device downwardly projects a plurality of split screens that form a single projection frame. The orientation of each of the plurality of splits screens is adjusted so that the graphical images in the split screens are viewed in proper directions from a plurality of positions near the projection frame.

A sixth aspect is a projector system including the projector device according to the third aspect and a plurality of external graphical signal generators connected to the projector device. The projector device generates a plurality of combined graphical images, each combining a plurality of different graphical images, adjusts the orientation of each combined graphical image in accordance with the selected projection mode, and projects the plurality of combined graphical images as a plurality of split screens included in a single projection frame. The orientation of each of the plurality of splits screens is adjusted so that the plurality of combined graphical images are viewed in proper directions from a plurality of positions near the projection frame.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a block diagram of a projector device according to a first embodiment of the present invention;

FIG. 2 is a block diagram of a graphical signal processor shown in FIG. 1;

FIG. 3 is a flowchart showing the procedures carried out by the projector device to display a graphical image;

FIG. 4 is a plan view showing a projection frame generated by the projector device of FIG. 1;

FIG. 5 is a block diagram of a projector device according to a second embodiment of the present invention;

FIG. 6 is a block diagram of a graphical signal processor shown in FIG. 5;

FIG. 7 is a plan view showing a projection frame generated by the projector device of FIG. 5;

FIGS. 8 to 10 are each plan views showing a projection frame generated by modifications of the projector device;

FIG. 11(a) is a diagram showing an example of how a short focal distance type LCD projector of the prior art is set;

FIG. 11(b) is a plan view showing a projection frame generated by the short focal distance type LCD projector of FIG. 11(a); and

FIG. 12 is a plan view showing a projection frame generated by a short focal distance type LCD projector of a reference example.

### DETAILED DESCRIPTION OF THE PREFERRED EMBODIMENTS

A projector device according to a first embodiment of the present invention will now be discussed. The projector device may be a short focal distance type, three-panel design liquid crystal design (LCD) projector. The projector device is operable in a single-input multi-screen display mode in which a plurality of (a maximum of four in the present embodiment) split screens 11 are displayed in a single projection frame 13. The same graphical image is simultaneously displayed in the plurality of split screens 11 in which the location and orientation of each graphical image is adjusted.

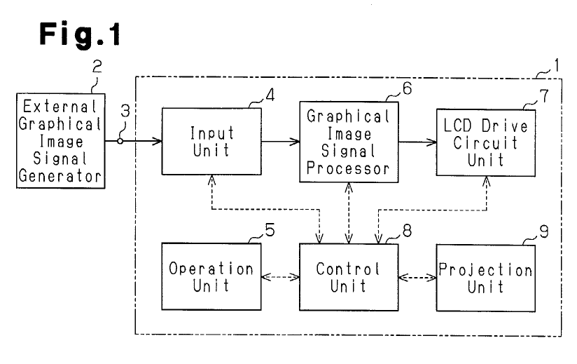

Referring to FIG. 1, an LCD projector 1 includes an input connector 3, which receives graphical signal data from an external graphical signal generator 2. An input unit 4 receives the graphical signal data via the input connector 3 and performs input processing on the graphical signal data. An operation unit 5 is used to select a projection mode for the LCD projector 1. A graphical signal processor 6 performs graphical signal processing on the graphical signal data processed by the input unit 4. An LCD drive circuit unit 7 drives an LCD panel. A digital-analog (D/A) converter (not shown) performs digital to analog conversion on the graphical signal data processed by the graphical signal processor 6 to generate analog graphical signal data, which is provided to the LCD drive circuit unit 7. The LCD projector 1 further includes a control unit 8, which controls the entire LCD projector 1, and a projection unit 9, which generates projection light that has undergone light modulation in the LCD panel.

The external graphical signal generator 2 is not especially limited and may be, for example, a computer. The input connector 3 includes a graphical signal input connector for receiving an analog RGB signal from a computer (computer input signal) and a graphical signal input connector for receiving an AV input signal (composite video signal).

The input unit 4 converts an input analog RGB signal (computer input signal) to a digital RGB signal. Further, the input unit 4 separates an received AV input signal into a luminance signal and chromaticity signal, converts the AV input signal to an analog RGB signal, and then converts the analog RGB signal to a digital RGB signal. An input signal converted into a digital RGB signal in this manner is provided to the graphical signal processor 6.

The operation unit 5 includes a power key, an input switch key, a menu key, and the like. The input switch key is used for switching an input signal between an analog RGB signal (computer input signal) and an AV input signal (composite video signal). The menu key is used to display a menu screen. The menu screen may include, for example, a screen for selecting a projection mode. When selecting the projection mode, the number of split screens in a projection frame, the layout of the split screens, and the size and orientation of each split screen may be selected. Alternatively, one of a plurality of projection modes in which the number of split screens in a projection frame, the layout of the split screens, and the size and orientation of each split screen are preset may be selected. In the first embodiment, the maximum number of split screens is four, and three or less split screens may be selected. A projection mode signal, which indicates the projection mode selected with the operation unit 5, is provided to the graphical signal processor 6 via the control unit 8.

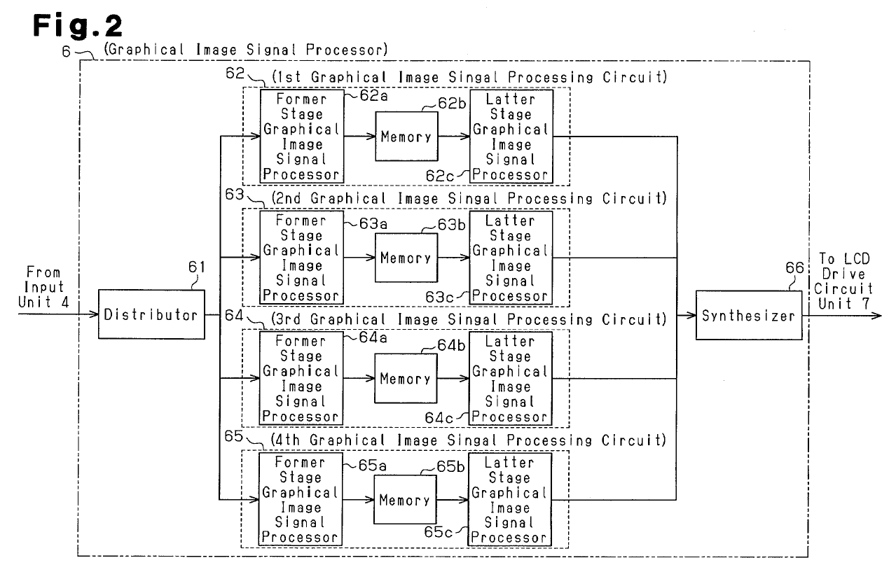

In accordance with the projection mode signal, the graphical signal processor 6 performs graphical signal processing on the graphical signal data. The graphical signal processor 6 will now be described with reference to FIG. 2. The graphical signal processor 6 includes a distributor 61 and first to fourth graphical signal processing circuits 62 to 65. It is preferable that the number of the graphical signal processing circuits 62 to 65 be in correspondence with the maximum number of selectable split screens (four in the first embodiment). The distributor 61 distributes the graphical signal data from the input unit 4 to the same number of graphical signal processing circuits as the number of split screens (four or less in the first embodiment) in the selected projection mode. The graphical signal processor 6 includes a synthesizer 66 that combines the graphical signal data processed by the graphical signal processing circuits 62, 63, 64, and 65. The graphical signal processing circuits 62, 63, 64, and 65 respectively include former stage graphical signal processing units 62a, 63a, 64a, and 65a, which convert, in accordance with the provided projection mode signal, the graphical signal data to data for a screen size conforming to the graphical image that is to be displayed in a split screen. The graphical signal processing circuits 62, 63, 64, and 65 also include memories 62b, 63b, 64b, and 65b for temporarily storing and synchronizing the graphical signal data processed by the former stage graphical signal processing units 62a, 63a, 64a, and 65a, respectively. Further, the graphical signal processing circuits 62, 63, 64, and 65 include latter stage graphical signal processing units 62c, 63c, 64c, and 65c for reading the data stored in the memories 62b, 63b, 64b, and 65b in accordance with the orientation at which it is to be displayed in the projection frame, respectively. The latter stage graphical signal processing units 62c, 63c, 64c, and 65c also adjust the converted graphical signal data in accordance with the location at which it is to be displayed in the projection frame and provides the adjusted data to the synthesizer 66.

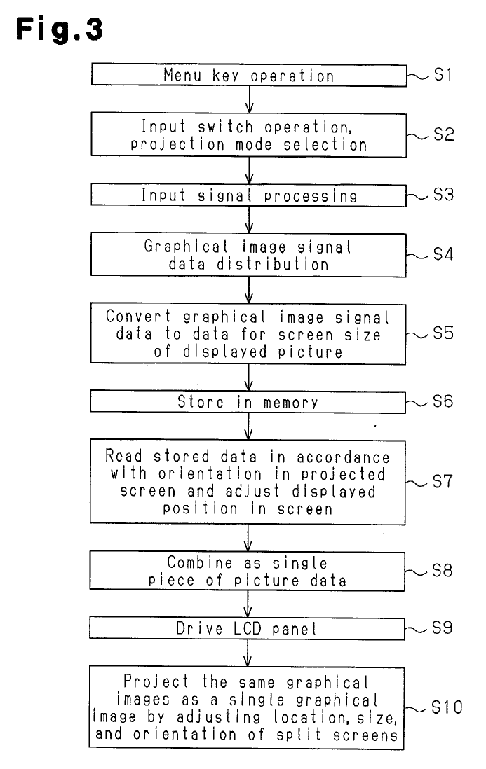

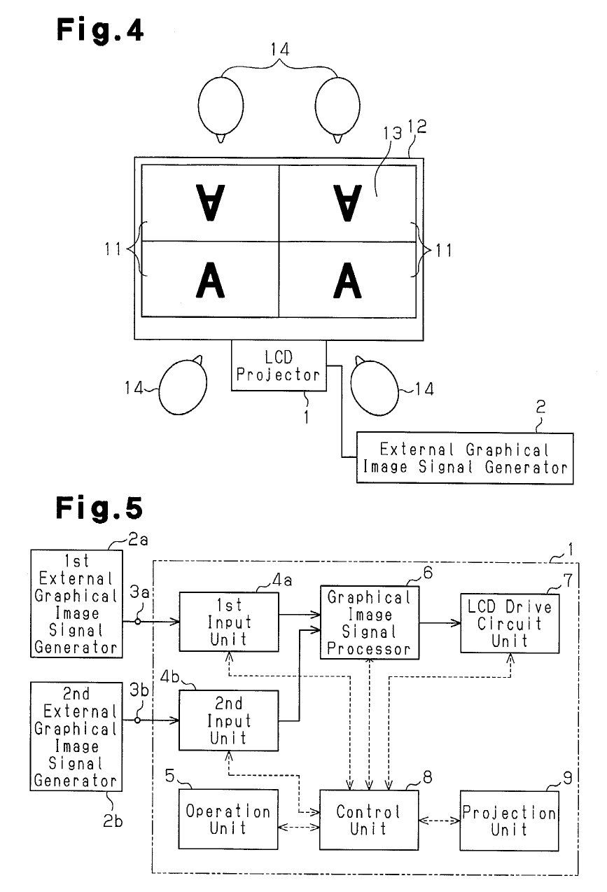

The procedures for displaying a graphical image with the LCD projector 1 will now be discussed with reference to FIGS. 3 and 4.

First, in step S1, an operator operates a menu key with the operation unit 5 and uses the menu screen to perform an input switching operation for obtaining an input signal from an external graphical signal generator. In step S2, the operator operates the menu key with the operation unit 5 to select a projection mode from the menu screen in accordance with the purpose of usage. For instance, a projection mode for the number, layout, and orientation of split screens as shown in FIG. 4 is selected. The LCD projector 1 of the first embodiment includes the four graphical signal processing circuits 62, 63, 64, and 65. Thus, the layout and orientation is selectable for each of four or less split screens.

Then, the input unit 4 performs input signal processing on the desired graphical signal data obtained through the input switching operation (step S3) and provides the processed digital RGB signal to the graphical signal processor 6. The distributor of the graphical signal processor 6 distributes the provided graphical signal data to the same number of graphical signal processing circuits (four in the example of FIG. 4, namely, the first to fourth graphical signal processing circuits 62 to 65) as the number of screens in the selected projection mode (step S4). The former stage graphical signal processing units 62a, 63a, 64a, and 65a convert the distributed graphical signal data to data for a screen size conforming to the split screen in the projection frame. Further, the former stage graphical signal processing units 62a, 63a, 64a, and 65a perform normal graphical signal processing such as image quality correction (step S5). Then, the processed graphical signals are stored in the memories 62b, 63b, 64b, and 65b (step S6). The latter stage graphical signal processing units 62c, 63c, 64c, and 65c read the data stored in the corresponding memories 62b, 63b, 64b, and 65b in accordance with the orientation in the projection frame, adjust the location allocated for the graphical image of the converted graphical signal data so that the graphical image is displayed at the selected location in the projection frame, and provides the adjusted data to the synthesizer 66 (step S7).

The synthesizer 66 combines the graphical signal data output from each of the signal processing circuits 62, 63, 64, and 65 to a single piece of graphical signal data (step S8) and provides the combined graphical signal data to the LCD drive circuit unit 7 (step S9). As a result of such processing, the projection frame 13, which includes the plurality of split screens 11 (four screens in this case, refer to FIG. 4), is displayed as a single screen (step S10). The plurality of split screens 11 forming the projection frame 13 simultaneously display the same graphical image, or a graphical image of the same contents. Further, in the projection frame 13, the location, size, and orientation of each split screen 11 is adjusted in accordance with the selected projection mode.

FIG. 4 shows an example of a conference projector system, which uses the LCD projector 1. The LCD projector 1 is arranged on a table surface 12. The LCD projector 1 is provided with graphical signal data from a single external graphical signal generator 2. Then, the LCD projector 1 projects the graphical signal data down onto the table surface 12 as a single projection frame 13. More specifically, the graphical image of the graphical signal data is simultaneously displayed in the plurality of split screens 11 with the orientation and layout that is in accordance with the selected projection mode. In the illustrated example, a plurality of viewers 14 are viewing the single projection frame 13 in a plurality of directions. The orientation and layout of the graphical image for each split screen 11 are adjusted so that the viewers 14 near the projection frame 13 can view the graphical image of a split screen 11 in the proper direction.

The first embodiment has the advantages described below.

(1) The LCD projector 1 of the first embodiment is capable of performing, in accordance with the selected projection mode, single-input multi-display in which the LCD projector 1 adjusts the layout and orientation of a plurality of screens for a single piece of input information and simultaneously displays the input information on the screens. Further, the LCD projector 1 is capable of performing, in accordance with the selected projection mode, single-input single-display, which is the most basic usage mode, in which the distributor 61 outputs the graphical signal data to a single graphical signal processing circuit, for example, the first graphical signal processing circuit 62.

(2) The projector system, which uses the LCD projector 1 of the first embodiment, displays the same graphical image in the plurality of split screens 11. The orientation and layout of the graphical images in the split screens 11 are adjusted so that the graphical images of the split screens 11 can be viewed in proper directions from a plurality of positions near the projection frame 13. Such graphical images can be projected downward from above. Accordingly, a graphical image that can be clearly seen is provided for all of the viewers 14 who are viewing the projection frame 13.

(3) In the projector system of the first embodiment, a graphical image is projected onto the table surface 12 in a conference room. The same graphical image (shown as character “A”) is displayed in each of the split screens 11 of the single projection frame 13. The orientation of the graphical image in each split screen 11 and the layout of the split screens 11 are adjusted so that the graphical images of the split screens 11 can be viewed in proper directions from a plurality of positions near the projection frame 13. Thus, all of the viewers 14 can view the corresponding split screen 11 from an angle that provides a clear view. This increases the efficiency for conveying information through the graphical image in the split screens 11. Therefore, for example, conferences may be carried out more efficiently by conveying information in such a manner.

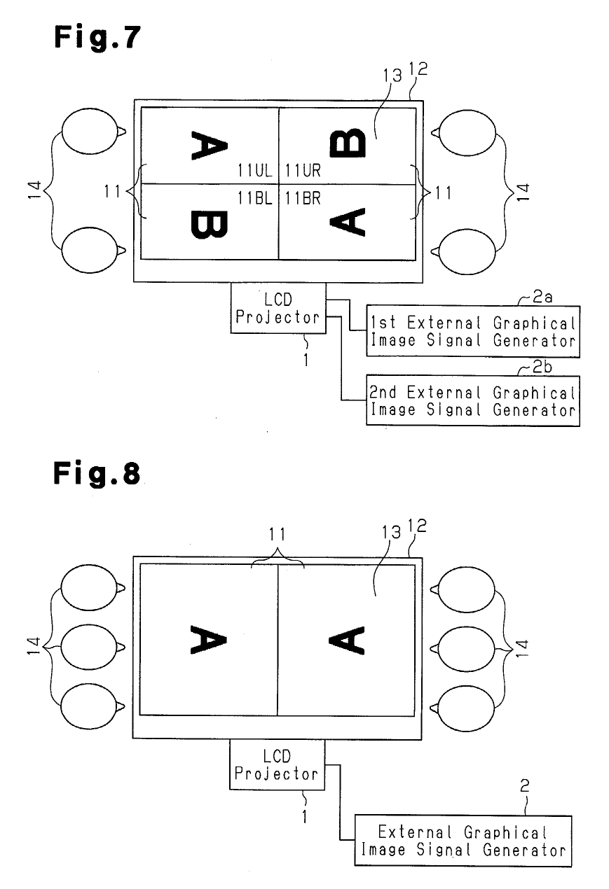

A projector device 1 according to a second embodiment of the present invention will now be discussed with reference to FIGS. 5 and 7. The projector device 1 is operable in a multi-input multi-screen display mode in which a combined graphical image combining different graphical images is displayed at locations that can be clearly viewed from near the projection frame 13. In FIGS. 5 to 7, like or same reference numerals are given to those components that are the same as the corresponding components of the first embodiment.

The LCD projector I retrieves the data of a plurality (two in this example) graphical signals from a plurality of (two in this example) external graphical signal generators 2a and 2b. More specifically, the LCD projector 1 includes a first input connector 3a, which is for connection with a first external graphical signal generator 2a, and a second input connector 3b, which is for connection with a second external graphical signal generator 2b. The first and second input connectors 3a and 3b retrieve graphical signal data from the first and second external graphical signal generators 2a and 2b, respectively. The first and second input connectors 3a and 3b each include a graphical signal input connector for receiving an analog RGB signal from a computer (computer input signal) and a graphical signal input connector for receiving an AV input signal (composite video signal).

A first input unit 4a performs input processing on the graphical signal data provided from the first external graphical signal generator 2a. A second input unit 4b performs input processing on the graphical signal data provided from the second external graphical signal generator 2b. The first and second input units 4a and 4b each process the input signal in the same manner as the input unit 4 of the first embodiment.

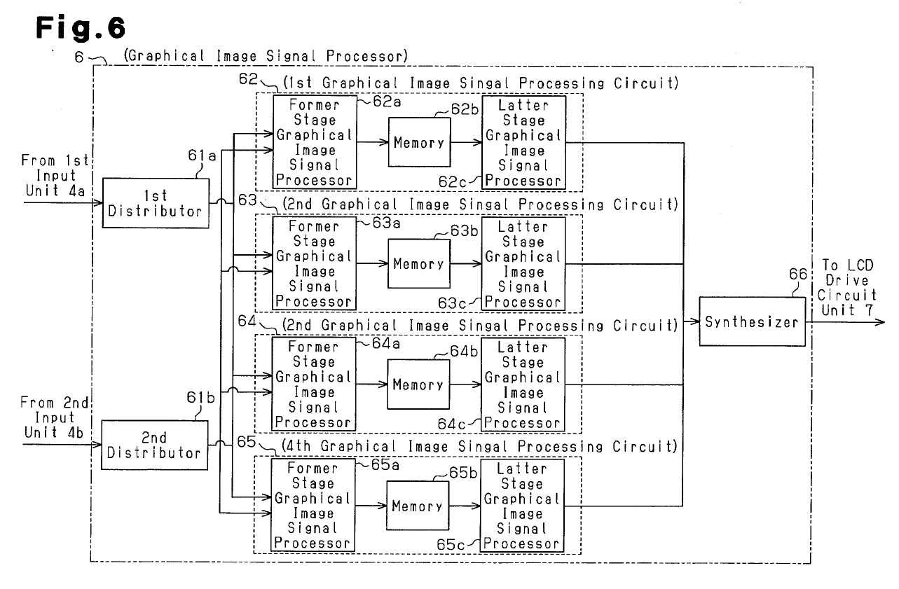

A graphical signal processor 6 will now be described with reference to FIG. 6. The graphical signal processor 6 includes a first distributor 61a, which provides graphical signal processing circuits 62, 63, 64, and 65 with graphical signal data that has been processed by the first input unit 4a. A second distributor 61b provides the graphical signal processing circuits 62, 63, 64, and 65 with graphical signal data that has been processed by the second input unit 4b. The graphical signal processing circuits 62, 63, 64, and 65 perform graphical signal processing on the graphical signal data provided from the distributors 61a and 61b in the same manner as in the first embodiment. When a projection mode for displaying the projection frame 13 shown in FIG. 7 is selected with the operation unit 5, the distributors 61a and 61b distribute the graphical signal data that has undergone input processing in the corresponding first and second input units 4a and 4b to two of the graphical signal processing circuits.

The graphical signal data from the first and second external graphical signal generators 2a and 2b is processed in the same manner as in the first embodiment. To display the single projection frame 13 including four split screens 11 as shown in FIG. 7, each of latter stage graphical signal processing units 62c, 63c, 64c, and 65c reads and adjusts the graphical signal data in accordance with the size, location, and orientation of the corresponding split screen 11. A synthesizer 66 then combines the graphical signal data provided from the latter stage graphical signal processing units 62c, 63c, 64c, and 65c to generate a single projection frame.

FIG. 7 shows an example of a conference projector system, which uses the LCD projector 1 of the second embodiment. The LCD projector 1 projects a single projection frame 13 onto a conference table surface 12. A plurality of viewers 14 are situated near the projection frame 13. The projection frame 13, which includes four split screens 11, simultaneously displays two different graphical images (shown as characters “A” and “B”), which are generated from two different pieces of graphical signal data, in different orientations. More specifically, in the set of the upper left split screen 11UL and the lower left split screen 11BL, two different graphical images (shown as characters “A” and “B”) are displayed next to each other oriented in the same direction that is proper for the viewers at the left side of the projection frame 13. In the set of the upper right split screen 11UR and the lower right split screen 11BR, two different graphical images (shown as characters “A” and “B”) are displayed next to each other oriented in the same direction that is proper for the viewers at the right side of the projection frame 13. The graphical images in the left set of the split screens 11UL and 11BL are oriented in directions opposite to the graphical images in the right set of the split screens 11UR and 11BR. The projector 1 projects a single projection frame 13 including the split screens 11 displaying graphical images in such a layout. As a result, all of the viewers 14 situated on opposite sides of the table surface 12 can simultaneously view two different graphical images (shown as characters “A” and “B”) in proper directions.

The second embodiment has the advantages described below.

(1) The number of displayable projection modes is increased. For example, (i) multi-input discrete screen display may be performed. More specifically, a plurality of different graphical images (shown as characters “A” and “B”) may be simultaneously displayed in different split screens 11, with the location and orientation of each graphical image being adjusted in accordance with the location of the corresponding split screen 11. (ii) Multi-input multi-screen display may be performed. More specifically, a plurality of different graphical images (shown as characters “A” and “B”) may be simultaneously displayed on different split screens 11, with the location and orientation of each set of different graphical images (for example, a combined graphical image formed by the split screens 11UL and 11BL and a combined graphical image formed by the split screens 11UR and 11BR) being adjusted in accordance with the location of the corresponding split screens 11. Thus, each set of combined graphical images may be displayed oriented in a direction providing a clear view from a position near the projection frame 13. (iii) When the LCD projector 1 is provided with graphical signal data from a single external graphical signal generator, single-input multi-screen display as described in the first embodiment may be performed. Further, single-input single screen display as described in the prior art section may be performed.

(2) In the projector system of the second embodiment, the projection frame 13, which is projected downward from above, is divided into the plurality of split screens 11, which display a plurality of different graphical images. Further, sets of combined graphical images are formed from the different graphical images, and the orientation of each set of combined graphical images is adjusted in accordance with the selected projection mode to project the sets of combined graphical images as a single projection frame 13. For example, the orientation of each set of combined graphical images is adjusted so that the set can be viewed upright from near the projection frame 13. In this manner, multi-input multi-screen display may be performed so that a combined graphical image combining a plurality of different graphical images is displayed in a state in which it can be clearly viewed from near the projection frame 13. Further, by using this projector system, all of the viewers 14 can simultaneously view different graphical image information from an angle that provides a clear view. This increases the efficiency for conveying information through the projected graphical images, and discussions may be carried out more efficiently by using such information. Further, conferences may be carried out efficiently by using such a projector system.

It should be apparent to those skilled in the art that the present invention may be embodied in many other specific forms without departing from the spirit or scope of the invention. Particularly, it should be understood that the present invention may be embodied in the following forms.

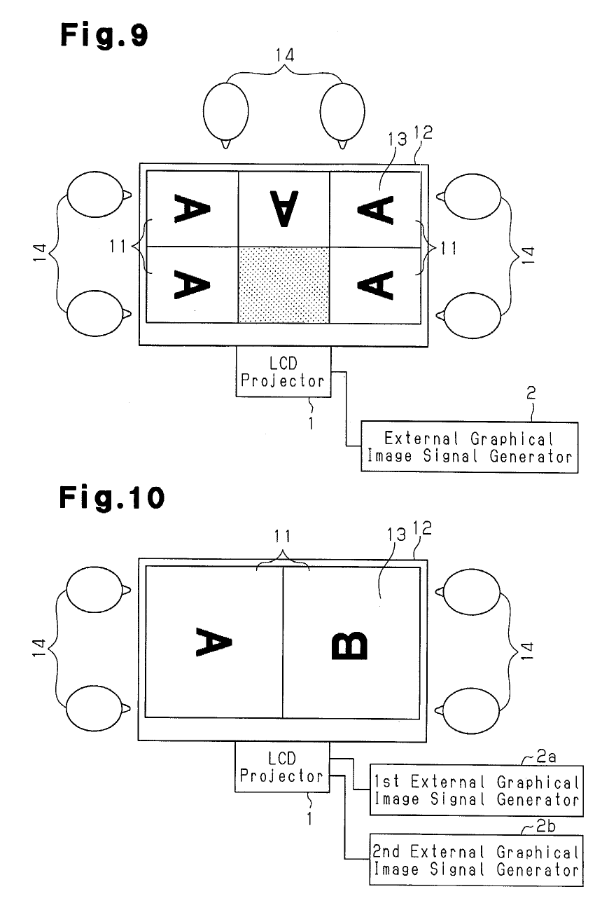

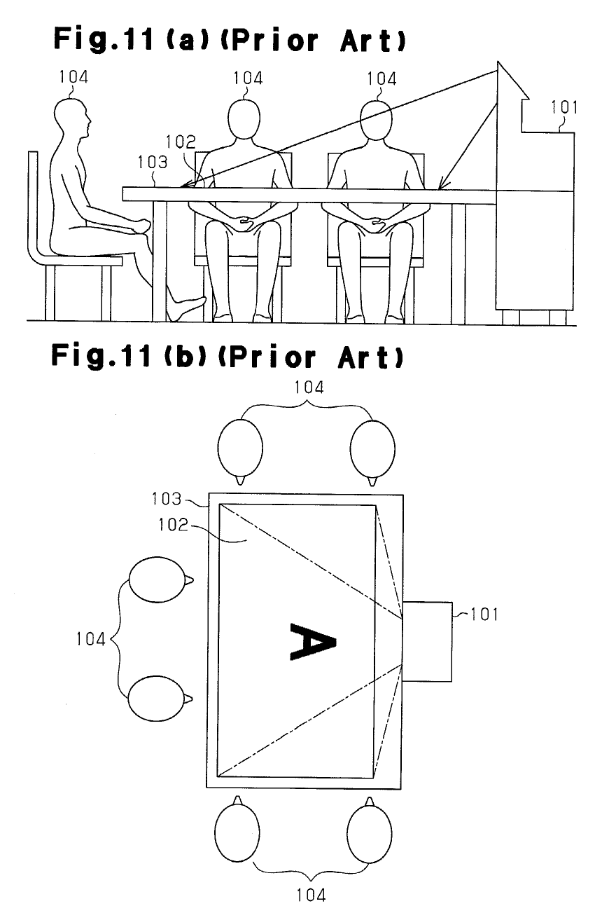

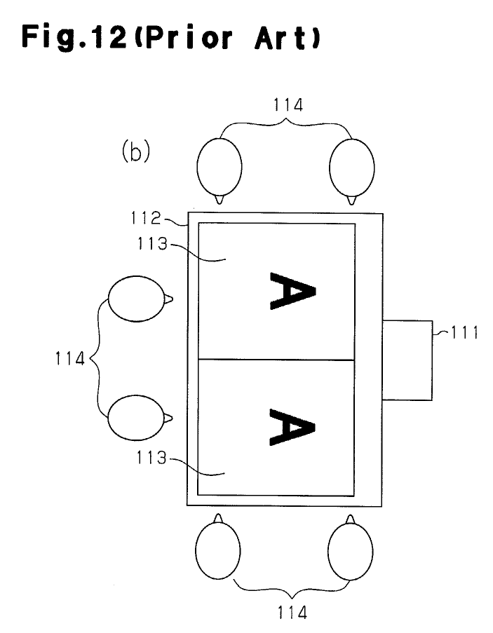

(1) In the first embodiment, the maximum number of split screens is four, and the number of graphical signal processing circuits is four in correspondence with the maximum number of split screens. However, the number of split screens and the number of graphical signal processing circuits may be changed to any appropriate number that is three or less or five or greater. FIG. 8 shows a modification in which the number of split screens and the number of graphical signal processing circuits is changed to two. FIG. 9 shows a modification in which the number of split screens and the number of graphical signal processing circuits is changed to five. In the modifications of FIGS. 8 and 9, one or more graphical images are displayed in the proper direction for each of the viewers 14 situated near the projection frame 13.

(2) In the first embodiment, an operator may select four or less split screens with the operation unit 5. For example, when two split screens are selected, the projector device of the first embodiment projects a projection frame 13 in which split screens 11 are laid out as shown in FIG. 8.

(3) In the second embodiment, two pieces of different graphical signal data are respectively distributed to two graphical signal processing circuits. However, such distribution may be eliminated. For example, each piece of graphical signal data may be provided to a single graphical signal processing circuit. In such a case, the projector device of the second embodiment projects a projection frame 13 in which split screens 11 are laid out as shown in FIG. 10.

(4) In the second embodiment, the external graphical signal generators, the input units, the distributors, and the graphical signal processing circuits may be increased in number. For example, if a projector device includes three input units, three distributors, and six graphical signal processing circuits, the maximum number of split screens in a projection frame would be six. Such a projector device would be connectable to three external graphical signal generators, and three different graphical images may be combined to form a set of combined graphical images so as to simultaneously display two sets of combined graphical images.

(5) In the second embodiment, there may be six graphical signal processing circuits. In such a case, two different graphical images may be combined to form a set of combined graphical images so as to simultaneously display three sets of combined graphical images. More specifically, the distributors 61a and 61b are provided with two pieces of graphical signal data from two external graphical signal generators, respectively. The distributors 61a and 61b than distribute the corresponding graphical signal data to three graphical signal processing circuits. Among three sets of combined graphical images, two are displayed as shown in FIG. 7 and one is displayed on the side opposite to the LCD projector 1. In this manner, two different graphical images may be displayed so as to provide a clear view from three directions around the projection frame.

(6) In the second embodiment, the number of graphical signal processing circuits may be decreased to two, and the first and second distributors 61a and 61b may be eliminated. Further, two graphical signal processing circuits may respectively be connected to the first and second external graphical signal generators 2a and 2b via an input unit. Such an LCD projector 1 would be able to simultaneously display two split screens oriented in different directions so that multi-input discrete screen display (particularly, two-input discrete screen display) can be performed. When forming a projector system with such an LCD projector 1, for example, split screens may be displayed as shown in the layout of FIG. 10.

(7) In the above-described embodiments, the three-panel design LCD projector 1 is used as a projector device. However, the present invention may be applied to an LCD projector 1 including other types of projection light generation systems.

(8) In the above-described embodiments, the LCD projector 1 is set to project a graphical image downward onto the table surface 12 from above. However, for example, by forming the top surface of a table from a transparent material such as glass, the LCD projector 1 may be set to project a graphical image onto the table surface 12 from below.

(9) In the above-described embodiments, the projector device is the LCD projector that includes an LCD panel functioning as a light modulation device. However, the projector device is not limited in such a manner and a projector device including other types of projection light generation system may also be used. For example, the present invention may be applied to a projector that performs Digital Light Processing (DLP) (registered trademark of Texas Instruments Incorporated.

(10) The application of the projector device is not limited to conferences. The projector device may be used in projector systems for various types of facilities.

The present examples and embodiments are to be considered as illustrative and not restrictive, and the invention is not to be limited to the details given herein, but may be modified within the scope and equivalence of the appended claims.

What is claimed is:

1. A projector device comprising:
an operation unit which selects a projection mode for designating the number of split screens forming a projection frame, the location of each split screen, the size of each split screen, and the orientation of each split screen;
an input connector connected to an external graphical signal generator;
an input unit which performs input signal processing on graphical signal data provided to the input connector from the external graphical signal generator to generate processed graphical signal data;
a distributor which distributes the processed graphical signal data generated in the input unit to a plurality of graphical signal processing circuits, with each of the graphical signal processing circuits performing data conversion and adjustment in accordance with the projection mode selected by the operation unit on the distributed graphical signal data to generate adjusted graphical signal data conforming to the size, location, and orientation of a corresponding one of the split screens;
a synthesizer which combines the adjusted graphical signal data provided from the plurality of graphical signal processing circuits to generate combined graphical signal data; and
a projection unit which projects the combined graphical signal data as a single projection frame.

2. A projector device comprising:
an operation unit which selects a projection mode for designating the number of split screens forming a projection frame, the location of each split screen, the size of each split screen, the orientation of each split screen, and graphical signal data that is to be displayed in each split screen;
a plurality of input connectors respectively connected to a plurality of external graphical signal generators;
a plurality of input units which each perform input signal processing on the graphical signal data provided to a corresponding one of the plurality of input connectors from a corresponding one of the plurality of external graphical signal generators to generate processed graphical signal data;
a plurality of graphical signal processing circuits which each perform data conversion and adjustment in accordance with the projection mode selected by the operation unit on the processed graphical signal data generated by one of the plurality of input units to generate adjusted graphical signal data conforming to the size, location, and orientation of a corresponding one of the split screens;
a synthesizer which combines the adjusted graphical signal data provided from the plurality of graphical signal processing circuits to generate combined graphical signal data; and
a projection unit which projects the combined graphical signal data as a single projection frame.

3. A projector device comprising:
an operation unit which selects a projection mode for designating the number of split screens forming a projection frame, the location of each split screen, the size of each split screen, the orientation of each split screen, and graphical signal data that is to be displayed in each split screen;
a plurality of input connectors respectively connected to a plurality of external graphical signal generators;
a plurality of input units which each perform input signal processing on the graphical signal data provided to a corresponding one of the plurality of input connectors from a corresponding one of the plurality of external graphical signal generators to generate processed graphical signal data;
a plurality of distributors which respectively receive the processed graphical signal data from the plurality of input units, with each of the distributors distributing the received processed graphical signal data to a plurality of graphical signal processing circuits, and each of the plurality of graphical signal processing circuits performing data conversion and adjustment in accordance with the projection mode selected by the operation unit on the processed graphical signal data generated by one of the plurality of input units to generate adjusted graphical signal data conforming to the size, location, and orientation of a corresponding one of the split screens;
a synthesizer which combines the adjusted graphical signal data provided from the plurality of graphical signal processing circuits to generate combined graphical signal data; and
a projection unit which projects the combined graphical signal data as a single projection frame.

4. A projector system comprising:
the projector device according to claim 1; and
a single external graphical signal generator connected to the projector device;
wherein the projector device downwardly projects a plurality of split screens that form a single projection frame; and
the orientation of a graphical image in each of the plurality of splits screens is adjusted so that the graphical images in the split screens are viewed in proper directions from a plurality of positions near the projection frame.

5. The projector system according to claim 4, wherein the projector system is set so as to project the plurality of splits screens forming the single projection frame onto a table surface.

6. A projector system comprising:
the projector device according to claim 3; and
a single external graphical signal generator connected to the projector device;
wherein the projector device downwardly projects a plurality of split screens that form a single projection frame; and
the orientation of a graphical image in each of the plurality of splits screens is adjusted so that the graphical images in the split screens are viewed in proper directions from a plurality of positions near the projection frame.

7. The projector system according to claim 6, wherein the projector system is set so as to project the plurality of splits screens forming the single projection frame onto a table surface.

8. A projector system comprising:
the projector device according to claim 3; and
a plurality of external graphical signal generators connected to the projector device;
wherein the projector device generates a plurality of combined graphical images, each combining a plurality of different graphical images, adjusts the orientation of each combined graphical image in accordance with the selected projection mode, and projects the plurality of combined graphical images as a plurality of split screens included in a single projection frame; and
the orientation of a graphical image in each of the plurality of splits screens is adjusted so that the plurality of combined graphical images are viewed in proper directions from a plurality of positions near the projection frame.

9. The projector system according to claim 8, wherein the projector system is set so as to project the plurality of splits screens forming the projection frame onto a table surface.
